(19) United States
(12) Patent Application Publication
(10) Pub. No.: US 2026/0161541 A1
(43) Pub. Date: Jun. 11, 2026

(54) COMPANION COMPUTE COMPONENTS OF MEMORY CONTROLLERS IN MEMORY DEVICES AND SYSTEMS

(71) Applicant: SK Hynix NAND Product Solutions Corp. (dba Solidigm), Rancho Cordova, CA (US)

(72) Inventors: Jason MOLGAARD, Windsor, CO (US); Vladimir ALVES, Newport Beach, CA (US); Steven WILLIAMS, Longmont, CO (US)

(21) Appl. No.: 18/977,616

(22) Filed: Dec. 11, 2024

(51) Int. Cl. G06F 12/02

(52) U.S. Cl. CPC G06F 12/0223

(57) ABSTRACT

This application is directed to a memory device including a non-volatile memory for storing user data, a first controller, and a companion compute component. The first controller is coupled to the non-volatile memory, and configured to receive a memory access request and access the non-volatile memory in response to the memory access request. The companion compute component is coupled to the first controller via a companion link, and the companion compute component and the first controller are distinct from one another. The companion compute component is configured to access the non-volatile memory storing the user data via the first controller and the companion link and process the user data internally in the memory device. In some embodiments, the first controller includes a host interface configured to enable data communication with a host device and a dedicated companion interface configured to enable data communication with the companion compute component.

### TECHNICAL FIELD

This application relates generally to a data storage device including, but not limited to, methods, systems, and devices for expanding functions of processors in a data storage device (e.g., a solid-state device (SSD)).

### BACKGROUND

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a storage controller to manage its memory space and process read, write, and read-modify-write requests from a host device efficiently with low latency. The secondary memory have been developed to integrate local in-memory data processing capabilities; however, these capabilities are often limited by the constrained processing and buffering resources available on the second memory, as well as the prioritization of memory management operations. The overall effectiveness and efficiency of in-memory data processing may be significantly impacted.

### SUMMARY

Various embodiments of this application are directed to methods, memory systems, and memory devices for pairing a controller with one or more companion compute components that supplement the controller with computational storage features. A controller of a memory device (e.g., an SSD) is configured to manage data storage, data retrieval, and interfacing with a host. In some embodiments, a memory device (also called a storage device) includes a plurality of processing cores, and is transformed to a computational storage device (CSD) by providing both a memory controller and a data processor using the plurality of processor cores. In some embodiments, the data processor is provided via the one or more companion compute components for processing internal computational storage operations (e.g., data processing operations) locally on the memory device. The memory controller of the memory device is configured to perform generic storage functions including memory access functions (e.g., input/output (I/O) access operations) and internal memory management functions. Further, in some embodiments, the internal computational storage operations of the memory device are customized based on a number and types of companion compute components included in the memory device.

In some embodiments, the memory controller is implemented in a system-on-chip (SoC) integrating multiple functionalities (e.g., memory management, error correction, and interface protocols) within a single substrate (e.g., a silicon chip, a printed circuit board). The memory controller has a power and thermal budget that is constrained by power and thermal characteristics of a package slot where the memory device is disposed, and an SoC associated with the memory controller has to deliver required functionalities within power and thermal constraints. When an SoC including a memory controller expands to incorporate computational storage functions, both a universal SoC having a large number of computational functions and an SoC having a configurable structure may be applied to meet a range of requirements of different memory devices and device families. For each memory device or device family, the universal SoC may include redundant computational functions that are not needed. Conversely, the configurable structure of the SoC is implemented based configurable and scalable companion compute components, which are configured to provide customized computational functions for each individual memory or device family. The SoC-based memory controller implemented with the configurable structure is more efficient in cost, device real estate, and power consumption compared with that implemented using the universal SoC.

In some embodiments, the memory device includes an SoC that further includes a memory controller, but not any companion compute component (e.g., corresponding to a data processor). The SoC is used in a first memory device without incurring additional manufacturing and assembling costs associated with the companion compute component. Alternatively, in some embodiments, the SoC includes at least one companion compute component (e.g., corresponding to a data processor) in addition to the memory controller, and is used in a second memory device to offer computational functions that are not available in the first memory device. By these means, the SoC may incur additional manufacturing and assembling costs if needed based on a number and types of companion compute components, thereby staying efficient in cost, device real estate, and power consumption for different memory devices.

In one aspect, a memory device includes a non-volatile memory for storing user data, a first controller coupled to the non-volatile memory, and a companion compute component coupled to the first controller via a companion link. The first controller is configured to receive a memory access request and access the non-volatile memory in response to the memory access request. The companion compute component and the first controller are distinct from one another, and the companion compute component is configured to access the non-volatile memory storing the user data via the first controller and the companion link and process the user data internally in the memory device.

In some embodiments, the first controller further includes a host interface configured to enable data communication with a host device and in compliance with a peripheral component interconnect express (PCIe) protocol. Further, in some embodiments, the host interface further includes a plurality of data lanes having a first subset of data lanes and a second subset of data lanes. The first subset of data lanes is configured to communicate data between the first controller and the host device. The second subset of data lanes is re-configured to communicate data between the first controller and the companion compute component.

In some embodiments, the first controller further includes a dedicated companion interface configured to enable data communication with the companion compute component. In some embodiments, the first controller includes both a dedicated companion interface configured to enable data communication with the companion compute component and a host interface configured to enable data communication with a host device and in compliance with a PCIe protocol.

In another aspect, some implementations include a memory device having a non-volatile memory for storing user data and a chip coupled to the non-volatile memory and including a first controller and a companion compute component. The first controller is coupled to the non-volatile memory, and configured to receive a memory access request and access the non-volatile memory in response to the memory access request. The companion compute component is coupled to the first controller via a companion link, and the companion compute component and the first controller are distinct from one another. The companion compute component is configured to access the non-volatile memory storing the user data via the first controller and the companion link and process the user data internally in the memory device.

In yet another aspect, some implementations include an electronic system that further includes a host device and a memory device of any of the above embodiments. The memory device is coupled to the host device.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a storage system of an example electronic device having one or more memory access queues, in accordance with some embodiments.

FIG. 3 is a block diagram of an example computer system that includes a storage system having an internal processing capability, in accordance with some embodiments.

FIG. 4 is a block diagram of an example computer system including a storage system that operates in compliance with a storage access and transport protocol, in accordance with some embodiments.

FIG. 5 is a block diagram of an example SoC of a memory device including a first controller, in accordance with some embodiments.

FIG. 6 is a block diagram of an example memory device, in accordance with some embodiments.

FIG. 7 a block diagram of an example memory device in which a companion link shares a data port of a host interface with a host device, in accordance with some embodiments.

FIG. 8 is a block diagram of an electronic system including a memory device coupled to a host device, in accordance with some embodiments.

FIG. 9 is a block diagram of an electronic system in which a host device and a CSD shares a storage, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

Various embodiments of this application are directed to methods, memory systems, and memory devices for pairing a controller with one or more companion compute components that supplement the controller with computational storage features. The controller provides at least generic storage functions including memory access functions and internal memory management functions, and the one or more companion compute components may be customized to provide custom computational storage features based on intended applications of different memory devices, thereby configuring the memory devices to different types of computational storage devices. In some embodiments, the controller may include a set of computational storage features by itself, and the set of computational storage features may be commonly used by different memory devices. In some embodiments, a subset of the one or more companion compute components provides computational storage features commonly used by different memory devices. Additionally, different computational storage devices may offer different levels of compute performance through different companion compute components included in the computational storage devices. In some embodiments, the memory devices may include an SoC-based controller configuration, independently of whether it remains a storage-focused memory device or is reconfigured to a computational storage device.

In some embodiments, a companion compute component includes a companion chip paired with a first controller including a memory controller to provide computational storage capabilities. In some implementations, the companion chip resides on an SoC including the memory controller based on chiplet technology. Alternatively, in some implementations, the companion chip resides in a different device package mounted on a motherboard jointly with a device package including the memory controller. The memory controller is configured to communicate with the companion chip based on a standard communications protocol. In some embodiments, a plurality of companion chips are paired with the memory controller implemented in an SoC. Each of the plurality of companion chips may be physically coupled in the SoC including the memory controller or included in a respective SoC distinct from the SoC including the memory controller.

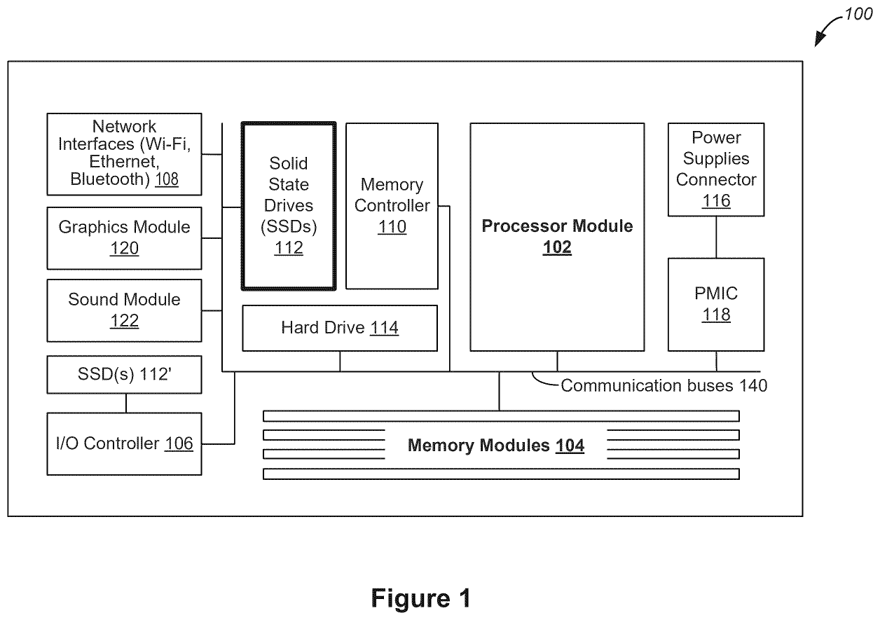

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a storage controller 110, SSD(s) 112, an HDD 114, power management integrated circuit (PMIC) 118, a graphics module 120, and a sound module 122. The storage controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

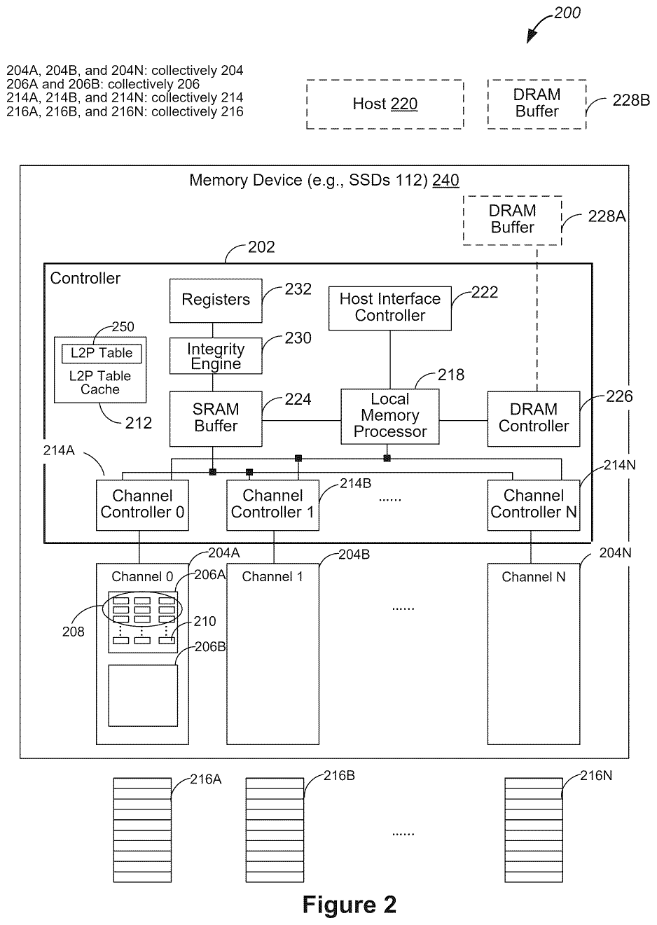

FIG. 2 is a block diagram of a storage system 200 of an example electronic device having one or more memory access queues, in accordance with some embodiments. The storage system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the storage system 200 and process the instructions and data to run an operating system (OS) and execute user applications. The storage system 200 includes one or more storage devices 240 (e.g., SSD(s)). Each storage device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each storage device 240 is formed on a printed circuit board (PCB).

Each memory channel 204 includes on one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the storage device 240 includes a plurality of superblocks. Each superblock includes a plurality of memory blocks each of which further includes a plurality of memory pages 210. For each superblock, the plurality of memory blocks are configured to be written into and read from the storage system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The storage device 240 stores information of an ordered list of superblocks in a cache of the storage device 240. In some embodiments, the cache is managed by a host driver of the host device 220, and called a host managed cache (HMC).

In some embodiments, the storage device 240 includes a single-level cell (SLC) NAND flash memory chip, and each memory cell stores a single data bit. In some embodiments, the storage device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the storage device 240 corresponds to a single queue 216 of memory access requests. Each memory access request is optionally received internally from the storage device 240 to manage the respective memory channel 204 or externally from the host device 220 to write or read data stored in the respective channel 204. Specifically, each memory access request includes one of: a system write request that is received from the storage device 240 to write to the respective memory channel 204, a system read request that is received from the storage device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a storage controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective input/output (I/O) access operation. Alternatively, in some embodiments, each of a system read request, a system write request, a host write request, and a host read request corresponds to a respective input/output (I/O) access operation

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in storage device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the storage device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the storage system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the storage system 200 includes a DRAM buffer 228A, and the L2P address indirection table 250 is stored in the DRAM buffer 228A. The local memory processor 218 of the controller 202 accesses the DRAM buffer 228A via a DRAM controller 226.

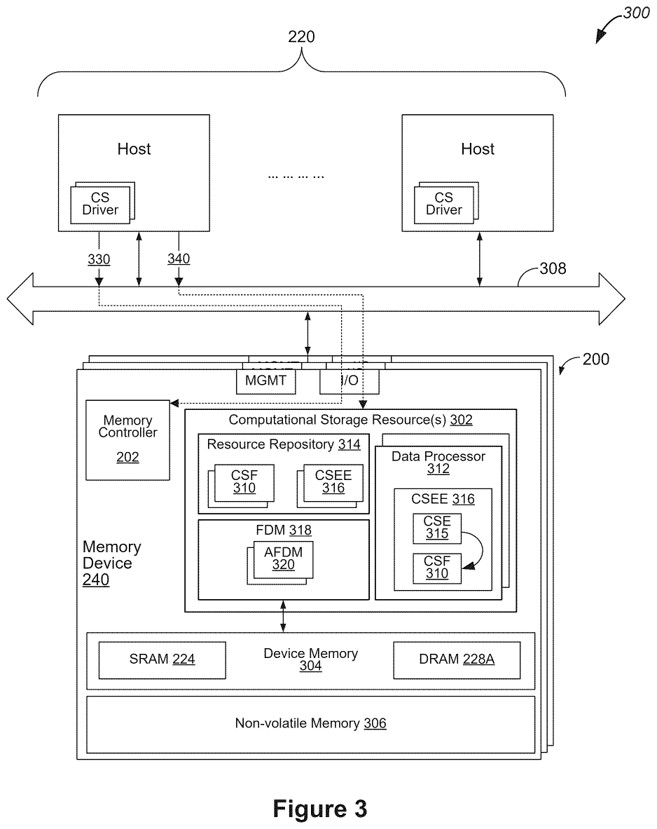

In some embodiments, a memory device 240 (also called a storage device) includes a plurality of processing cores, and is transformed to a computational storage device (CSD) by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., input/output (I/O) access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

FIG. 3 is a block diagram of an example computer system 300 that includes a storage system 200 having an internal processing capability, in accordance with some embodiments. The storage system 200 is also called a computational storage device (CSD), and includes one or more storage devices 240 (e.g., SSDs). Each storage device 240 further includes a storage controller 202, a volatile memory 304, and a non-volatile memory 306 (e.g., memory channels 204). The host device(s) 220 and the one or more storage devices 240 of the storage system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The storage controller 202 accesses the non-volatile memory 306 in response to the memory access operations. Additionally, in some embodiments, the storage controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each storage device 240 further includes one or more of a L2P table cache 212, a SRAM buffer 224, and a DRAM buffer 228A, and is configured to store data temporarily while the storage controller 202 accesses the non-volatile memory 306 for memory accesses or internal memory management.

In some embodiments, the storage controller 202 is dedicated to processing the memory access requests and internal memory management functions. A storage device 240 further includes one or more computational storage resources (CSRs) 302 configured to implement data processing operations locally on the storage device 240. A set of predefined data processing operations are implemented to perform a computational storage function (CSF) 310, which is distinct from the memory access and internal memory management functions performed by the storage controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the storage device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a storage device 240 of the storage system 200, and the storage controller 202 of the storage device 240 receives the memory read or write request 330 and accesses the non-volatile memory 306 accordingly. Alternatively, in some embodiments, a host device 22 issues a data processing request 340 to the storage device 240, and a data processor 312 of the computational storage resource 302 (e.g., the computational storage engine 315) receives the data processing request 340 and processes user data extracted from the data processing request or the non-volatile memory 306.

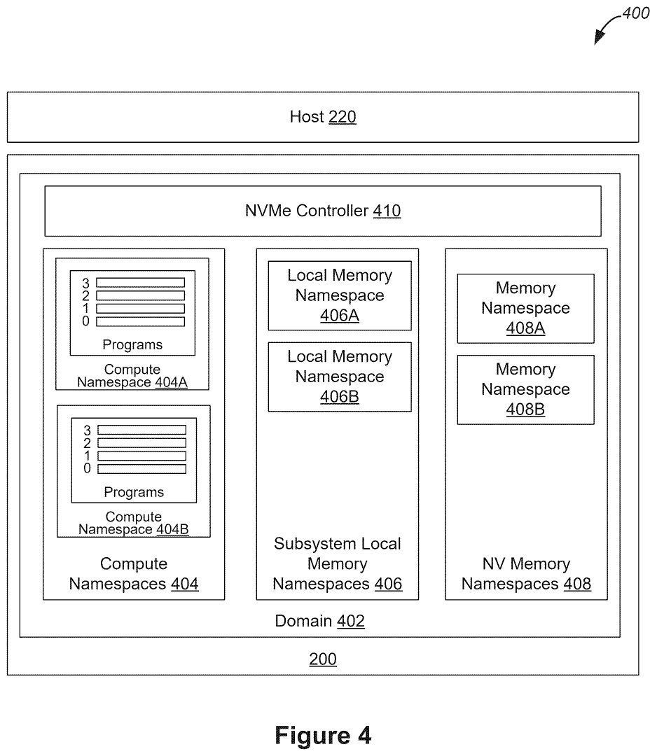

FIG. 4 is a block diagram of an example computer system 400 including a storage system 200 that operates in compliance with a storage access and transport protocol (e.g., nonvolatile memory express (NVMe)), in accordance with some embodiments. The storage system 200 includes one or more storage devices 240 each of which corresponds to a domain 402 according to the storage access and transport protocol. Each domain 402 corresponding to a respective storage device 240 includes a one or more compute namespace 404, local memory namespaces 406, memory namespaces 408, and a domain controller 410. Each namespace is a collection of LBAs accessible to, or associated with, a respective one of the plurality of programs.

A storage device 240 includes one or more processors having a computation capability (e.g., a storage controller 202, a data processor 312), a volatile memory 304 (e.g., a cache 212, a SRAM buffer 224, a DRAM buffer 228A), and a non-volatile memory 306. When the storage device 240 executes a plurality of programs, resources of the storage controller 202, the volatile memory 304, and the non-volatile memory 306 are allocated to implement the plurality of programs based on the storage access and transport protocol (e.g., NVMc). A plurality of compute namespaces 404 (e.g., 404A and 404B) correspond to, are configured to provide, instructions of the plurality of programs executed by the one or more programs of the storage device 240. Resources of the volatile memory 304 are allocated based on a plurality of local memory namespaces 406 (e.g., 406A and 406B) to facilitate execution of the plurality of programs by the storage device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the storage device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the storage device 240 are managed according to the storage access and transport protocol.

In some embodiments, the storage access and transport protocol includes a NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each storage device 240 (e.g., SSD) as a standard NVMe storage device using the NVMe protocol. The host device 220 is configured to read and write data and implement data processing operations on the storage device 240 using NVMe commands.

In some embodiments, the host device 220 uses an operating system (e.g., a Linux operating system), and the CSRs 302 (FIG. 3) of the storage device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the storage device 240.

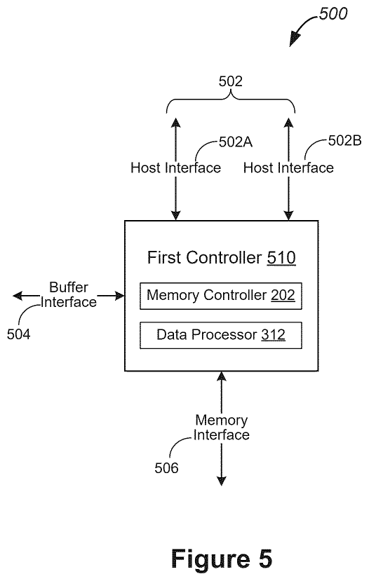

FIG. 5 is a block diagram of an example SoC 500 of a memory device 200 including a first controller 510, in accordance with some embodiments. The first controller 510 includes one or more host interfaces 502 (e.g. two host interfaces 502A and 502B), a buffer interface 504, and a memory interface 506. In some embodiments, the two host interfaces 502A and 502B are configured to couple the first controller 510 to two distinct host devices 220. Each host interface 502 may include a data port. In some embodiments, the buffer interface 504 is configured to couple the first controller 510 to a DRAM buffer 228A or 228B (FIG. 2), which may include a DDR SDRAM. In some embodiments, the memory interface 506 is configured to couple the first controller 510 to a non-volatile memory 306 (e.g., including a plurality of memory channels 204 in FIG. 2). In an example, the non-volatile memory 306 includes NAND flash memory. Each of the interfaces 502, 504, and 506 may be configured to manage instructions, operation states, or data associated with at least storage functions including memory access functions (e.g., input/output (I/O) access operations) and internal memory management functions.

In some embodiments, the first controller 510 includes a memory controller 202 configured to perform storage functions including memory access functions (e.g., input/output (I/O) access operations) and internal memory management functions. Alternatively, in some embodiments, the first controller 510 includes a memory controller 202 configured to perform the storage functions and a data processor 312 configured to perform computational storage functions 310 (e.g., data processing). In some embodiments, the first controller 510 includes a plurality of processing cores configured to provide the memory controller 202 and the data processors 312 via two separate subsets of processing cores. In some embodiments, the memory controller 202 and the data processor 312 of the first controller 510 at least partially share certain hardware resources in a time-multiplexed manner.

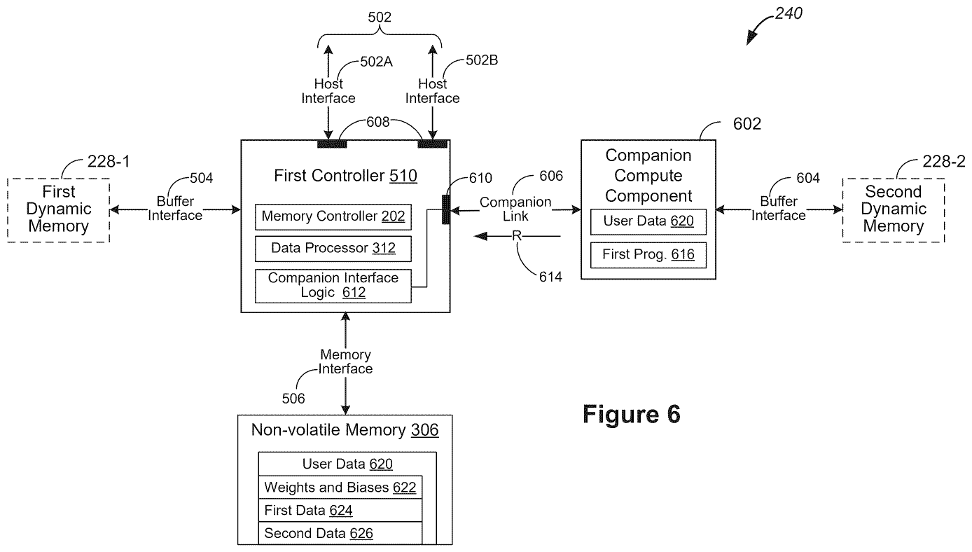

FIG. 6 is a block diagram of an example memory device 240, in accordance with some embodiments. The memory device 240 includes a first controller 510, a companion compute component 602, and a non-volatile memory 306 for storing user data 620. The first controller 510 is coupled to the non-volatile memory 306, and configured to receive a memory access request 614 (e.g., from a host device 220 or the companion compute component 602) and access the non-volatile memory in response to the memory access request 614. The companion compute component 602 is distinct from the first controller 510. In some embodiments, the companion compute component 602 may be located at a different substrate from the first controller 510, allowing the memory device 240 to be flexibly applied with or without the companion compute component 602. The companion compute component 602 is configured to access the non-volatile memory 306 storing the user data 620 via the first controller 510 and a companion link 606 and process the user data 620 internally in the memory device 240.

In some embodiments, the first controller 510 includes one or more host interfaces 502 (e.g. two host interfaces 502A and 502B), a first buffer interface 504, and a memory interface 506. In some embodiments, each of the one or more host interfaces 502 is configured to enable data communication with a respective host device 220 (FIG. 2) and in compliance with a PCIe protocol. In some embodiments, the companion compute component 602 further includes a second buffer interface 604 distinct from the first buffer interface 504, and the second buffer interface 604 is configured to store program codes, temporary computation state, or the user data 620 that are processed by the companion compute component 602.

In some embodiments, the first controller 510 is electrically, mechanically, and communicatively coupled to the companion compute component 602 via the companion link 606. The first controller 510 and the companion compute component 602 are configured to exchange data (e.g., memory access request 614, user data 620) via the companion link 606. In some embodiments, the first controller 510 has a dedicated companion data port 610 (e.g., having a plurality of data lanes) to which the companion link 606 is coupled. The dedicated companion data port 610 is distinct from a data port 608 of a host interface 502 that is further coupled to a host device 220.

In some embodiments, the memory device 240 further includes a first dynamic memory 228-1 and a second dynamic memory 228-2 distinct from the first dynamic memory 228-1. The first dynamic memory 228-1 is coupled to the first controller 510, and configured to store data (e.g., user data 620) when the first controller 510 accesses the non-volatile memory 306 in response to the memory access request 614. The second dynamic memory 228-2 is coupled to the companion compute component 602, and configured to store programs, computation states, or the user data 620 processed by the companion compute component 602. Conversely, in some embodiments, the first dynamic memory 228-1 and the second dynamic memory 228-2 are two subsets of a common dynamic memory (e.g., DRAM buffer 228A in FIG. 2). The first controller 510 and the companion compute component 602 are coupled to the common dynamic memory, and assigned (e.g., dynamically) with the two subsets of the common dynamic memory, respectively.

In some embodiments, the first controller 510 includes a memory controller 202 and a companion interface logic 612. The memory controller 202 is configured to perform storage functions. The companion interface logic 612 is coupled to the companion compute component 602 via the companion link 606 and configured to control the companion compute component 602. In some embodiments, the memory controller 202 is physically distinct from the companion interface logic 612, and includes a first subset of the first controller 510, and the companion interface logic 612 includes a second subset of the first controller 510 that is distinct from the first subset of the first controller 510. In some embodiments, the first subset of the first controller 510 is configured to provide the memory controller 202 during a first time duration and the companion interface logic 612 during a second time duration that does not overlap with the first time duration. Stated another way, in different embodiments, the first controller 510 and the companion interface logic 612 may be implemented using different hardware resources of the first controller 510 or using different time allocations of the same hardware resources of the first controller 510.

Further, in some embodiments, the first controller 510 includes a data processor 312 configured to perform computational storage functions 310 (e.g., data processing), in addition to the memory controller 202 and the companion interface logic 612. The memory controller 202 and the data processor 312 may be implemented using different hardware resources of the first controller 510 or using different time allocations of the same hardware resources. Alternatively, the data processor 312 and the companion interface logic 612 may be implemented using different hardware resources of the first controller 510 or using different time allocations of the same hardware resources. In some embodiments, the computational storage functions 310 performed by the data processor 312 of the first controller 510 include a set of generic storage functions 310 applicable in a plurality of different memory devices 240, and the companion compute component 602 is selectively added to provide a set of customized storage functions for each individual memory device 240.

In some embodiments, the first controller 510 is formed at least partially on a first chiplet, and the companion compute component 602 is formed at least partially on a second chiplet distinct from the first chiplet. Further, in some embodiments, a first chiplet is coupled to the non-volatile memory 306 and includes the first controller 510, and a second chiplet is coupled to the first chiplet and includes the companion compute component 602. Each chiplet may include an integrated circuit formed on a chip or die. The companion link 606 is configured to communicate data (e.g., the user data 620) between the first controller 510 and the companion compute component 602 based on a Universal Chiplet Interconnect Express (UCIe) protocol, a PCIe protocol, or another chiplet link protocol that has been available or will be made available in the future. Stated another way, in some embodiments, the companion link 606 includes a die-to-die interconnect and serial bus between the first chiplet and the second chiplet and complies with the UCIe, PCIe, or another chiplet link protocol.

Further, in some embodiments, the first controller 510 and the companion compute component 602 are included in the same SoC. For example, the first chiplet associated with the first controller 510 and the second chiplet associated with the companion compute component 602 are stacked on one another and mounted in an SoC package. In an example, the first chiplet associated with the first controller 510 and the second chiplet associated with the companion compute component 602 are disposed on a substrate of the SoC package. Alternatively, in some embodiments, the first controller 510 is included in a first SoC, and the companion compute component 602 is included in a second SoC. The first chiplet associated with the first controller 510 and the second chiplet associated with the companion compute component 602 are disposed on two distinct substrates, and assembled in two distinct SoC packages, which may be disposed on a substrate of a common PCB.

In some embodiments, the first controller 510 is formed at least partially on a first chip, and the companion compute component 602 is formed at least partially on a second chip distinct from the first chip. The companion link 606 may include a die-to-die interconnect and serial bus coupled between the first chip and the second chip, e.g., based on the UCIe. Further, in some embodiments, the first chip associated with the first controller 510 and the second chip associated with the companion compute component 602 are stacked on one another and mounted in an SoC package. In another example, both the first chip and the second chip are disposed on a substrate of the SoC package. Alternatively, in some embodiments, the first chip associated with the first controller 510 is included in a first SoC, and the second chip associated with the companion compute component 602 is included in a second SoC. The first chip and the second chip are assembled in two distinct SoC packages, which may be disposed on a substrate of a common PCB.

In some embodiments, the companion compute component 602 is applied to provide data processing capabilities internally in the memory device 240, e.g., without directly involving the host device 220 in data processing. For example, a data inference process of machine learning may be implemented using the companion compute component 602. The user data 620 stored in the non-volatile memory 306 include weights and biases 622 of a machine learning model, first data 624, and second data 626. The first controller 510 is configured to receive the memory access request 614 from the companion compute component 602, extract the weights and biases 622 from the non-volatile memory 306, and provide the weights and biases 622 to the companion compute component 602. The companion compute component 602 is configured to execute a first program 616. In accordance with a determination that the first data 624 satisfies an execution condition of the first program 616, the companion compute component 602 applies the machine learning model to process the first data 624 stored in the non-volatile memory 306 and generate the second data 626 to be stored in the non-volatile memory 306. For example, an execution condition of the first program 616 is satisfied when a feature event (e.g., detection of an abnormality) occurs or based on a predefined schedule. In some embodiments, the first data 624 include one or more image frames, and the machine learning model is applied to process the first data 624 and generate the second data 626 identifying objects in the image frames.

In some embodiments, a first subset of the first data 624, the weights and biases 622, and the second data 626 is communicated between the first controller 510 and the companion compute component 602 via the companion link 606. For example, the weights and biases 622 are extracted from the non-volatile memory 306 by the first controller 510 and provided to the companion link 606. Additionally, in some embodiments, a second subset of the first data 624, the weights and biases 622, and the second data 626 is communicated between the first controller 510 and the companion compute component 602 via a buffer (e.g., including the dynamic memories 228-1 and 228-2) without using the companion link 606. Each of the first controller 510 and the companion compute component 606 has a respective buffer interface 504 or 604 to access the buffer. For example, the first controller 510 extracts a subset of the first data 624 and temporarily stores the subset of the first data 624 in the buffer from which the companion compute component 602 may obtain the subset of the first data 624 for further processing.

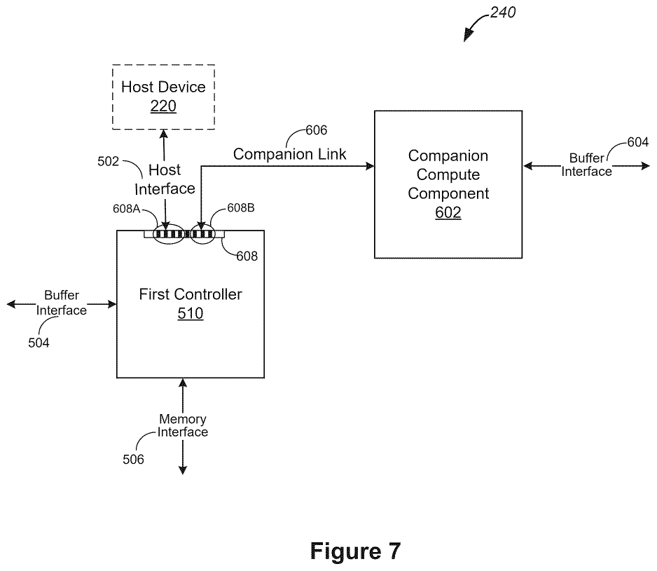

FIG. 7 is a block diagram of another example memory device 240 in which a companion link 606 shares a data port 608 of a host interface 502 with a host device 220, in accordance with some embodiments. The data port 608 includes a plurality of data lanes, and a subset of the plurality of lanes of the data port 608 is repurposed to provide a companion interface coupled to the companion link 606 for exchanging data with the companion compute component 602 via the companion link 606. Stated another way, the data port 608 of the host interface 502 includes a plurality of data lanes having a first subset of data lanes 608A and a second subset of data lanes 608B. The first subset of data lanes 608A is configured to communicate data between the first controller 510 and the host device 220, and the second subset of data lanes 608B is re-configured to communicate data between the first controller 510 and the companion compute component 602.

Alternatively, in some embodiments not shown, the companion link 606 shares one or more first data lanes (e.g., a subset or all) of the data port 608 of the host interface 502 with the host device 220 in a time-multiplexed manner. During a first duration of time (e.g. corresponding to a first duty cycle), the one or more first data lanes of the data port 608 of the host interface 502 are entirely applied to communicate data for the host device 220. During a second duration of time (e.g., corresponding to a second duty cycle), the one or more first data lanes of the data port 608 of the host interface 502 are entirely applied to communicate data for the companion compute component 602 via the companion link 606. The second duration of time is distinct from, and does not overlap with, the first duration of time. The second duty cycle is distinct from, and does not overlap with, the first duty cycle.

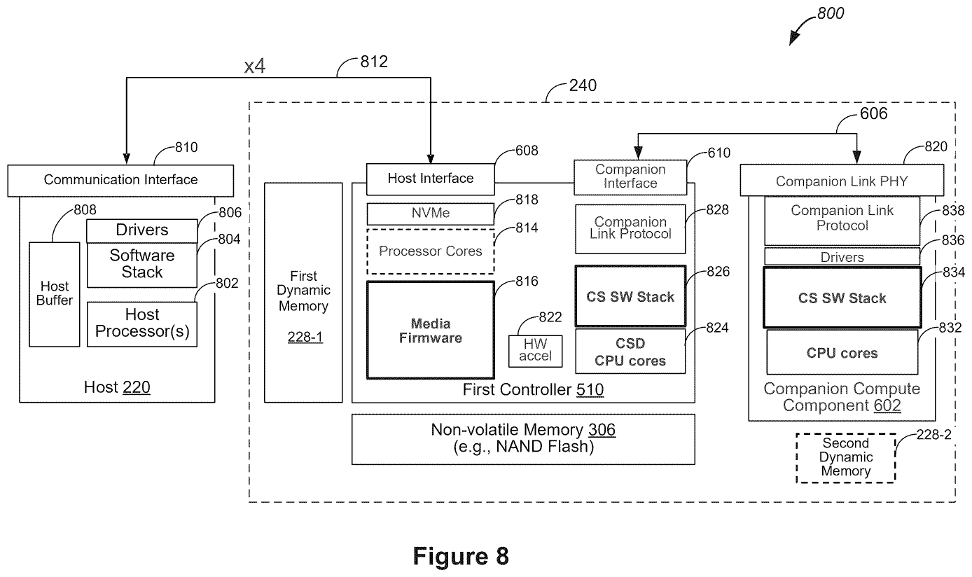

FIG. 8 is a block diagram of an electronic system 800 including a memory device 240 coupled to a host device 220, in accordance with some embodiments. In some embodiments, the electronic system 800 includes two separate sets of hardware, firmware, and software components for implementing both storage functions (e.g., memory access, internal memory management) and computational storage functions 310 (e.g., data processing). A first controller 510 functions at least as a memory controller 202 when memory read/write commands are received from the host device 220, and may further facilitate the companion compute component 602 to implement the computational storage functions 310 when computational storage commands are received from the companion compute component 602. In some embodiments, the companion compute component 602 includes one or more of: a central processing unit (CPU), a graphics processing unit (GPU), a digital signal processor (DSP), an application-specific integrated circuit (ASIC), a microcontroller unit (MCU), a field-programmable gate array (FPGA), a neural processing unit (NPU), a quantum processor, a co-processor, a multi-core processor, a system on a chip (soc), a hardwired accelerator or engine, and a memory. In some embodiments, the companion compute component 602 may be any form of computational resources configured to perform operations on user data 620 stored on the non-volatile memory 306.

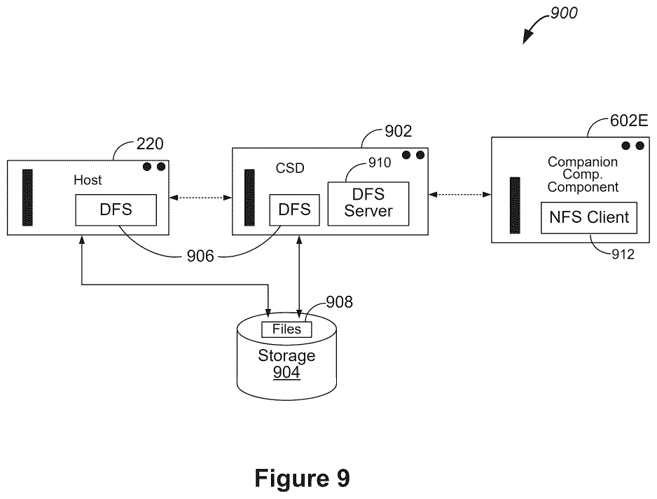

In some embodiments, the electronic system 800 includes the host device 220, the first controller 510 (e.g., including a memory controller 202), and the companion compute component 602 (e.g., a data processor 312), and is coupled in a virtual network. The host device 220 and the companion compute component 602 shares non-volatile storage media (e.g., a non-volatile memory 306). In some embodiments, a filesystem (e.g., DFS 906 in FIG. 9) is shared between the host device 220 and the companion compute component 602 and applied to manage files (e.g., files 908 in FIG. 9) stored on the non-volatile memory 306.

More specifically, in some embodiments, the host device 220 includes one or more of: one or more host processors 802, a host software stack 804, one or more drivers 806, a host buffer 808, and a communication interface 810. The host software stack 804 includes a host operating system and one or more programs, and the one or more host processors 802 are configured to execute the host software stack 804 and store data temporarily in the host buffer 808. Each of the one or more drivers 806 includes a piece of software that enables communication between the host operating system or program and a hardware or peripheral device (e.g., a memory device 240). The host device 220 is coupled to the memory device 240 via a data bus 812 (e.g., using a PCIe protocol).

In some embodiments, the memory device 240 includes the first controller 510, the companion compute component 602, the non-volatile memory 306, a first dynamic memory 228-1 coupled to the first controller 510, and a second dynamic memory 228-2 coupled to the companion compute component 602. A first subset of the first controller 510 includes at least a first set of one or more processor cores 814 used as the memory controller 202, media firmware 816, an NVMe system 818, and a host interface 502, and is configured to perform storage functions including memory access functions (e.g., input/output (I/O) access operations) and internal memory management functions. In some embodiments, a second subset of the first controller 510 includes a companion interface logic 612, which further includes a second set of one or more processor cores 824, a computational storage software stack 826, a companion link protocol 828, and a companion interface 610, and is configured to perform computational storage functions 310 (e.g., processing data using a machine learning model) within the memory device 240.

In some embodiments, the first controller 510 further includes a hardware accelerator 822 configured to implement one or more computational workloads. Stated another way, in some embodiments, the hardware accelerator 822 provides one or more basic computational storage functions 310 locally on the first controller 510, while the companion compute component 602 provides additional computational storage functions 310. In some implementations, the hardware accelerator 822 includes GPUs (Graphics Processing Units), FPGAs (Field-Programmable Gate Arrays), or dedicated AI chips, which are integrated into or closely coupled with the first subset of the first controller 510, e.g., to improve speed and efficiency for tasks such as data compression, encryption, and machine learning inference. In some embodiments, by parallelizing operations and processing data directly within the memory controller 202, the hardware accelerator 822 reduces latency and bandwidth constraints, enabling faster data access and manipulation. The memory device 240 is applied in high-performance computing environments, data centers, and applications requiring rapid data processing and real-time analytics.

The first controller 510 is further coupled to the companion compute component 602 via a companion link 606. In some embodiments, the companion compute component 602 includes one or more of: one or more processors 832, a computational storage software stack 834, one or more drivers 836, a companion link protocol 838, and a communication interface 820. The software stack 834 includes an operating system and/or one or more programs, and the one or more processors 832 are configured to execute the software stack 834 and store data temporarily in the second dynamic memory 218-2. Each of the one or more drivers 836 includes a piece of software that enables communication between an embedded operating system or program of the companion compute component 602 and a hardware or peripheral device (e.g., the first controller 510).

FIG. 9 is a block diagram of an electronic system 900 in which a host device 220 and a computational storage device (CSD) 902 shares a storage 904, in accordance with some embodiments. In some embodiments, a memory device 240 includes a plurality of processing cores, and is transformed to the computational storage device 902 by configuring two separate subsets of processing cores to a memory controller 202 and a data processor (e.g., data processor 312 in FIG. 3), respectively. The data processor 312 is configured to process internal computational storage operations (e.g., data processing operations) locally on the memory device 240. The memory controller 202 of the memory device 240 specializes in performing generic storage functions including memory access functions (e.g., input/output (I/O) access operations) and internal memory management functions. The storage 904 of the electronic system 900 includes a non-volatile memory 306 having a plurality of memory channels 204. In some embodiments, the CSD 902 includes one or more internal companion compute components (not shown in FIG. 9). In some embodiments, the computational storage device 902 is coupled to one or more external companion compute components 602E, which provides additional data processing functions the computational storage device 902 does not have.

In some embodiments, the electronic system 900 is configured to execute a distributed filesystem (DFS) 906 for managing files 908 (e.g., user data 620 in FIG. 6) that are stored in the storage 904. The files 908 are accessible to both the host device 220 and the companion compute component 602E via the computational storage device 902. In some embodiments, the computational storage device 902 runs a network filesystem (NFS) server 910, allowing the companion compute component 602 to be coupled to the computational storage device 902 as an NFS client 912. The companion compute component 602 and the host device 220 have the same view of the files 908 stored in the storage 904, and are configured to request the files 908 for processing in the same manner.

In some embodiments, memory access operations (e.g., write, read) are implemented with a direct access path to the storage 904. Memory access requests are issued by the host device 220 or the companion compute component 602E, and forwarded to the memory controller 202 of the CSD 902, which accesses the storage 904 to read or write associated data on behalf of the host device 220 or the companion compute component 602E. In some embodiments, the memory access requests are not intercepted by alternative circuitry distinct from the memory controller 202. A latency of a memory access request issued by the host device 220 is consistent between a first memory device having no computational storage functions and a CSD 902 including the companion compute component 602E.

In some embodiments, the companion compute component 602E may be selected based on an application (e.g., a program), thereby providing different levels of performances or features while the CSD 902 remains unchanged. In some embodiments, the storage 904 is accessible at a filesystem level by both the host device 220 and the companion compute component 602E using one or more filesystem technologies (e.g., a distributed filesystem, a network filesystem).

More specifically, the CSD 902 includes a first controller 510 configured to run a network filesystem (NFS) server module 910 and manage the user data 620 (FIG. 6) stored in the non-volatile memory 306 according to a distributed network filesystem 906. Further, in some embodiments, the companion compute component 602E includes an NFS client module 912 configured to connect the companion compute component 602E to the first controller 510, and is configured to request the user data 620 for processing based on the distributed network filesystem 906. Additionally, in some embodiments, the first controller 510 is coupled to a host device 220, and the host device 220 is configured to request the user data 620 for processing based on the distributed network filesystem 906.

Various implementations of this application include a memory device 240 that includes, or is coupled to, a companion compute component 602 to incorporate one or more additional computational storage functions. Further, in some embodiments, the memory device 240 is a computational storage device that includes one or more generic computational storage functions. In some embodiments, a first controller 510 of the memory device 240 includes a dedicated companion interface 610 (FIG. 6) configured to receive a companion link 606 and exchange data with the companion compute component 602 via the companion link 606. Alternatively, in some embodiments, the first controller 510 of the memory device 240 leverages a data port 608 (FIG. 7) coupled to a host interface 502, and allocates a subset of data lanes of the data port 608 to receiving the companion link 606 and communicating with the companion compute component 602 via the companion link 606.

In some embodiments, the memory device 240 further includes a companion interface logic in addition to a memory controller 202, which is configured to implement generic storage functions, such as memory access functions (e.g., input/output (I/O) access operations) and internal memory management functions. In some embodiments, both the companion compute component 602 and the memory controller 202 are included in an SoC. Alternatively, in some embodiments, the companion compute component 602 and the memory controller 202 are included in two distinct SoCs. In some embodiments, the companion compute component 602 and the host device 220 share a non-volatile memory 306 (e.g., a storage 904), e.g., using a DFS. Further, in some embodiments, the companion compute component 602 interfaces with the shared non-volatile memory 306 as an NFS client using a network filesystem (NFS).

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. A memory device, comprising: a non-volatile memory for storing user data; a first controller coupled to the non-volatile memory, wherein the first controller is configured to receive a memory access request and access the non-volatile memory in response to the memory access request; and a companion compute component coupled to the first controller via a companion link, wherein the companion compute component and the first controller are distinct from one another, and the companion compute component is configured to access the non-volatile memory storing the user data via the first controller and the companion link and process the user data internally in the memory device.

Clause 2. The memory device of clause 1, wherein the first controller further comprises a host interface configured to enable data communication with a host device and in compliance with a peripheral component interconnect express (PCIe) protocol.

Clause 3. The memory device of clause 2, wherein: the host interface further comprises a plurality of data lanes having a first subset of data lanes and a second subset of data lanes; the first subset of data lanes is configured to communicate data between the first controller and the host device; and the second subset of data lanes is re-configured to communicate data between the first controller and the companion compute component.

Clause 4. The memory device of clause 1 or 2, wherein the first controller further comprises a dedicated companion interface configured to enable data communication with the companion compute component.

Clause 5. The memory device of any of clauses 1-4, further comprising: a first dynamic memory coupled to the first controller and configured to store data when the first controller accesses the non-volatile memory in response to the memory access request; and a second dynamic memory coupled to the companion compute component and configured to store programs, computation states, or the user data processed by the companion compute component, the second dynamic memory distinct from the first dynamic memory.

Clause 6. The memory device of any of clauses 1-5, wherein the first controller includes a memory controller and a companion interface logic, and the companion interface logic is coupled to the companion compute component via the companion link and configured to control the companion compute component.

Clause 7. The memory device of clause 6, wherein the memory controller is physically distinct from the companion interface logic, and includes a first subset of the first controller, and the companion interface logic includes a second subset of the first controller that is distinct from the first subset of the first controller.

Clause 8. The memory device of clause 6 or 7, wherein a first subset of the first controller is configured to provide the memory controller during a first time duration and the companion interface logic during a second time duration that does not overlap with the first time duration.

Clause 9. The memory device of any of clauses 1-8, wherein the first controller is formed at least partially on a first chiplet, and the companion compute component is formed at least partially on a second chiplet distinct from the first chiplet, and wherein the companion link is configured to communicate data between the first controller and the companion compute component based on a Universal Chiplet Interconnect Express (UCIe) protocol or a PCIe protocol.

Clause 10. The memory device of clause 9, wherein the first chiplet and the second chiplet are stacked on one another and mounted in a package.

Clause 11. The memory device of clause 9, wherein the first chiplet and the second chiplet are disposed on a substrate.

Clause 12. The memory device of clause 9, wherein the first chiplet and the second chiplet are assembled in two separate packages and disposed on a printed circuit board (PCB).

Clause 13. The memory device of any of clauses 1-12, wherein the companion compute component includes one or more of: a central processing unit (CPU), a graphics processing unit (GPU), a digital signal processor (DSP), an application-specific integrated circuit (ASIC), a microcontroller unit (MCU), a field-programmable gate array (FPGA), a neural processing unit (NPU), a quantum processor, a co-processor, a multi-core processor, a system on a chip (SoC), a hardwired accelerator or engine, and a memory.

Clause 14. The memory device of any of clauses 1-13, wherein the first controller is configured to run a network filesystem (NFS) server module and manage the user data stored in the non-volatile memory according to a distributed network filesystem.

Clause 15. The memory device of clause 14, wherein the companion compute component includes an NFS client module configured to connect the companion compute component to the first controller, and is configured to request the user data for processing based on the distributed network filesystem.

Clause 16. The memory device of clause 15, wherein the first controller is coupled to a host device, and the host device is configured to request the user data for processing based on the distributed network filesystem.

Clause 17. The memory device of any of clauses 1-16, wherein: the user data stored in the non-volatile memory include weights and biases of a machine learning model, first data, and second data; the first controller is configured to receive the memory access request from the companion compute component, extract the weights and biases from the non-volatile memory, and provide the weights and biases to the companion compute component; and the companion compute component is configured to execute a first program by, in accordance with a determination that the first data stored in the non-volatile memory satisfies an execution condition of the first program, applying the machine learning model to process the first data stored in the non-volatile memory and generate the second data.

Clause 18. The memory device of clause 17, wherein a first subset of the first data, the weights and biases, and the second data is communicated between the first controller and the companion compute component via the companion link.

Clause 19. The memory device of clause 17 or 18, wherein a second subset of the first data, the weights and biases, and the second data is communicated between the first controller and the companion compute component via a buffer without using the companion link, each of the first controller and the companion compute component having a respective buffer interface to access the buffer.

Clause 20. The memory device of any of clauses 1-19, wherein a first chiplet is coupled to the non-volatile memory and includes the first controller, and a second chiplet is coupled to the first chiplet and includes the companion compute component.

Clause 21. An electronic system, comprising: a host device; and a memory device of any of clauses 1-20, the memory device coupled to the host device.

Each of the above identified elements may be stored in one or more of the previously mentioned storage devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A memory device, comprising:
a non-volatile memory for storing user data;
a first controller coupled to the non-volatile memory, wherein the first controller is configured to receive a memory access request and access the non-volatile memory in response to the memory access request; and
a companion compute component coupled to the first controller via a companion link, wherein the companion compute component and the first controller are distinct from one another, and the companion compute component is configured to access the non-volatile memory storing the user data via the first controller and the companion link and process the user data internally in the memory device.

2. The memory device of claim 1, wherein the first controller further comprises a host interface configured to enable data communication with a host device and in compliance with a peripheral component interconnect express (PCIe) protocol.

3. The memory device of claim 2, wherein:
the host interface further comprises a plurality of data lanes having a first subset of data lanes and a second subset of data lanes;
the first subset of data lanes is configured to communicate data between the first controller and the host device; and
the second subset of data lanes is re-configured to communicate data between the first controller and the companion compute component.

4. The memory device of claim 1, wherein the first controller further comprises a dedicated companion interface configured to enable data communication with the companion compute component.

5. The memory device of claim 1, further comprising:
a first dynamic memory coupled to the first controller and configured to store data when the first controller accesses the non-volatile memory in response to the memory access request; and
a second dynamic memory coupled to the companion compute component and configured to store programs, computation states, or the user data processed by the companion compute component, the second dynamic memory distinct from the first dynamic memory.

6. The memory device of claim 1, wherein the first controller includes a memory controller and a companion interface logic, and the companion interface logic is coupled to the companion compute component via the companion link and configured to control the companion compute component.

7. The memory device of claim 6, wherein the memory controller is physically distinct from the companion interface logic, and includes a first subset of the first controller, and the companion interface logic includes a second subset of the first controller that is distinct from the first subset of the first controller.

8. The memory device of claim 6, wherein a first subset of the first controller is configured to provide the memory controller during a first time duration and the companion interface logic during a second time duration that does not overlap with the first time duration.

9. The memory device of claim 1, wherein the first controller is formed at least partially on a first chiplet, and the companion compute component is formed at least partially on a second chiplet distinct from the first chiplet, and wherein the companion link is configured to communicate data between the first controller and the companion compute component based on a Universal Chiplet Interconnect Express (UCIe) protocol or a PCIe protocol.

10. The memory device of claim 9, wherein the first chiplet and the second chiplet are stacked on one another and mounted in a package.

11. The memory device of claim 9, wherein the first chiplet and the second chiplet are disposed on a substrate.

12. The memory device of claim 9, wherein the first chiplet and the second chiplet are assembled in two separate packages and disposed on a printed circuit board (PCB).

13. The memory device of claim 1, wherein the companion compute component includes one or more of: a central processing unit (CPU), a graphics processing unit (GPU), a digital signal processor (DSP), an application-specific integrated circuit (ASIC), a microcontroller unit (MCU), a field-programmable gate array (FPGA), a neural processing unit (NPU), a quantum processor, a co-processor, a multi-core processor, a system on a chip (SoC), a hardwired accelerator or engine, and a memory.

14. The memory device of claim 1, wherein the first controller is configured to run a network filesystem (NFS) server module and manage the user data stored in the non-volatile memory according to a distributed network filesystem.

15. The memory device of claim 14, wherein the companion compute component includes an NFS client module configured to connect the companion compute component to the first controller, and is configured to request the user data for processing based on the distributed network filesystem.

16. The memory device of claim 15, wherein the first controller is coupled to a host device, and the host device is configured to request the user data for processing based on the distributed network filesystem.

17. The memory device of claim 1, wherein:
the user data stored in the non-volatile memory include weights and biases of a machine learning model, first data, and second data;
the first controller is configured to receive the memory access request from the companion compute component, extract the weights and biases from the non-volatile memory, and provide the weights and biases to the companion compute component; and
the companion compute component is configured to execute a first program by, in accordance with a determination that the first data stored in the non-volatile memory satisfies an execution condition of the first program, applying the machine learning model to process the first data stored in the non-volatile memory and generate the second data.

18. The memory device of claim 17, wherein a first subset of the first data, the weights and biases, and the second data is communicated between the first controller and the companion compute component via the companion link.

19. The memory device of claim 17, wherein a second subset of the first data, the weights and biases, and the second data is communicated between the first controller and the companion compute component via a buffer without using the companion link, each of the first controller and the companion compute component having a respective buffer interface to access the buffer.

20. A memory device, comprising:
a non-volatile memory for storing user data; and
a first chiplet coupled to the non-volatile memory and including a first controller; and
a second chiplet coupled to the first chiplet and including a companion compute component;
wherein the first controller is coupled to the non-volatile memory, and configured to receive a memory access request and access the non-volatile memory in response to the memory access request; and
wherein the companion compute component is coupled to the first controller via a companion link, and the companion compute component and the first controller are distinct from one another, and wherein the companion compute component is configured to access the non-volatile memory storing the user data via the first controller and the companion link and process the user data internally in the memory device.

21. An electronic system, comprising:
a host device; and
a memory device coupled to the host device, wherein the memory device further comprises:
a non-volatile memory for storing user data;
a first controller coupled to the non-volatile memory, wherein the first controller is configured to receive a memory access request and access the non-volatile memory in response to the memory access request; and
a companion compute component coupled to the first controller via a companion link, wherein the companion compute component and the first controller are distinct from one another, and the companion compute component is configured to access the non-volatile memory storing the user data via the first controller and the companion link and process the user data internally in the memory device.
